(19) United States
(12) Patent Application Publication
(10) Pub. No.: US 2021/0388758 A1
(43) Pub. Date: Dec. 16, 2021

(54) COMBUSTION ENGINE

(71) Applicant: Manuel Exposito CARBALLADA, Vila Pavao (BR)

(72) Inventor: Manuel Exposito CARBALLADA, Vila Pavao (BR)

(21) Appl. No.: 17/420,672

(22) PCT Filed: Nov. 11, 2019
(86) PCT No.: PCT/BR2019/050482

§ 371 Date: Jul. 4, 2021

(30) Foreign Application Priority Data
Jan. 24, 2019 (BR) BR 10 2019 001522

(51) Int. Cl. F02B 55/10; F02B 55/02; F02F 7/00

(52) U.S. Cl. CPC F02B 55/10; F02F 7/0043; F02B 55/02

(57) ABSTRACT

The present invention relates to a structural arrangement for a stationary internal combustion engine for machines or vehicles (universal), which can use various types of fuel. More specifically, the present invention relates to an internal combustion engine with improved combustion efficiency, improved thermodynamic efficiency, reduced dimensions, an improved power-to-weight ratio that exceeds that of aircraft turbine engines using the Brayton thermodynamic cycle, and up to three times less fuel consumption and gas emissions into the environment.

### FIELD OF THE INVENTION

The present invention refers to a structural arrangement for a universal internal combustion engine, stationary, for machines, or mounted on a vehicle, being able to use different types of fuels. More specifically, the present invention refers to an internal combustion engine with improved combustion thermodynamic efficiency, efficiency, better with reduced fuel consumption, low emission of gases into the environment and minimal size.

### BACKGROUND OF THE INVENTION

The current engines used in transport vehicles such as, aviation, train, boat, etc. machines and stationary were invented in the late nineteenth century. Over the years, improvements have been made to the aforementioned engines, for example, thermal efficiency initially went from 5% to close to 30% in the laboratory.

The rate of emission of gases into the atmosphere was also reduced, directly impacting a less polluted air. However, this old engine design is practically on the edge.

Thus, in order to provide the technique with a more modern and more efficient engine arrangement, the present invention was developed, making it possible to reach nearly triple the efficiency of current engines, since the engine presented here uses a cycle thermodynamic much more efficient.

### SUMMARY OF THE INVENTION

The present invention refers to a combustion engine, mixed alternative rotary formed by one or more sectors for multiple uses such as: Stations, vehicles, machines, etc. More specifically, the present invention relates to a structural arrangement for an internal combustion engine, using different types of fuels. The vehicle can be either land, sea, rail or air. More specifically, the present invention relates to an internal combustion engine with improved combustion efficiency, better thermodynamic efficiency, reduced dimensions, greater power/weight ratio that surpasses airplane turbines that use the Brayton thermodynamic cycle, with reduced consumption of fuels and emission of gases into the environment, up to 3 times less.

### BRIEF DESCRIPTION OF THE FIGURES

FIG. 1 shows an internal combustion engine without the external accessories.

FIGS. 2A and 2B show the engine shaft with cam and ring.

FIGS. 3A and 3B show the subassembly (ring) of the present invention.

FIG. 4 shows the cam of the subassembly of the present invention.

FIGS. 5A and 5B show the subassembly of the engine shaft with the eccentric shaft plus the red ring of the present invention.

FIG. 6 shows the subassembly of the seal vanes of the present invention.

FIG. 7 shows the structural block for the frame of the engine elements of the present invention.

FIG. 8 shows the cover that separates the engine sectors of the present invention.

FIG. 9 shows the thermodynamic profile of the engine of the present invention.

FIGS. 10A and 10B show a subassembly inside with the shaft, the cam, the ring, the passages and the block, they form the combustion or compression chambers.

### DETAILED DESCRIPTION OF THE INVENTION

The present invention relates to a combustion engine, mixed alternative rotary formed by one or more sectors for universal use. More particularly, the structural arrangement of the engine presented here is simple, comprising few moving elements, which simplifies the manufacturing and assembly process, requiring the presence of small radiators to cool the system. The system can also be cooled with air. Said engine comprises only the following sets of movable elements: The ring, the shaft together with the cam and the seal blades.

The characteristics of this engine, provide a structural arrangement with reduced dimensions, but capable of performing a thermodynamic cycle in each turn of the shaft as many times as combustion chambers have with very high efficiency.

A person skilled in the art recognizes that the term sectors used here, comprises a minimum set of parts necessary for the formation of an engine.

The structural arrangement presented here, provides the technique of an engine in which the first part of the cycle, the compression occurs in one or more stages, without their limit. The thermodynamic cycle that uses this engine is more efficient than those currently used, as the compression is carried out in one or more steps. With the intermediate cooling, which considerably reduces the effort required to carry out the compression, and in the expansion process, it makes the most of the energy of the gases. However, in this cycle, the energy generated by the fuel is used as much as possible with minimal waste.

Compression is performed in a compression chamber in the first step and equal in the following steps to a smaller and smaller volume each followed by the cooling of the system between stages by radiators to the environment, and further compressing in the combustion chamber, it can it is also possible to inject sprayed water into the combustion chamber to further cool the last compression that is made inside this combustion chamber, in this way a compression close to isentropic is done, then comes the explosion and then the expansion, during this last process of expansion takes the energy in the adiabatic expansion up to the suction pressure value as much as possible.

This arrangement has a quiet exhaust and low temperature. As previously mentioned, since the exhaust pressure is very low, the noise and temperature are also low.

Said engines presented here, in addition to being used for land vehicles, are engines that can be designed for universal applications in any size with very high power/weight ratio, which allows them to be used in aviation, due to their much greater efficiency than In the Brayton cycle of turbines, it is possible to improve power with a consumption much lower than that demanded by the turbines and with less weight, more power and long service life, which is due to the very low relative speed of friction between the internal parts of the engine.

Engines for power plants of more than 1,000,000 KW can be manufactured. Currently the biggest known engine has only 100,000 KW and it is very heavy, as its weight reaches over 2300 tons and this engine of the invention would weigh close to 30 tons for that same power.

The engine presented here completes several cycles in each of the combustion sectors, comprising a turn of the shaft, which makes it very light and powerful. By way of illustration, but not limitation, a three-sector engine with 16 combustion chambers per sector can be used, which in each revolution would generate 48 explosions (cycles).

The torque of this engine is very high and continuous with little oscillation which allows low revolutions per minute, therefore, lower consumption at minimum rpm. Torque can be improved by tilting the seal vanes to a pre-determined laboratory-proven angle and only when the seal vanes are arranged on the block.

Additionally, the engine can be regenerative, accumulating energy in the compression part in an extra tank, which works as a reserve tank, only in vehicles such as trucks, trains, etc. The extra tank, when the vehicle makes the descent movement, can accumulate compressed air that is later used in the climbs as extra energy reused free of charge, without having to use a brake for descent.

During reuse, the condensing water from the extra tank at the reserve pressure can be reinjected at the end of the combustion cycle for a system cooling without energy cost. This cooling occurs at the time of exhaust, further cooling the combustion sections of the system.

The heating of the system is completely uniform around the engine without hot spots and is very low. The system can be cooled with a fan fitted to the counter balance between the sectors.

The arrangement proposed here has a straight, round and flat design without strange curves.

The engine proposed here has low friction speed between its elements, promoting high revolutions per minute. By way of illustration, but not limitation of the present invention, a high power sports vehicle can have 20,000 rpm. or more. The speed of the seal-blades against the ring or against the block is minimal, since it oscillates, having alternating movements back and forth, achieving perfect lubrication of the seal-blades with very low consumption of lubricating oil.

Alternatively, using special materials, such as Teflon, self-lubricating metals, among others with similar characteristics, it would be possible to still eliminate the consumption of lubricating oil, including the use of bearings to further reduce friction in some parts of the system (axes).

The engine object of the present invention can be arranged in very small spaces, contributing to a greater useful space in every transport vehicle. With respect to air vehicles, for example, planes; this engine has a low front section, reducing drag. These mixed turbofan engines can be made (with inverter included in the propeller, tube propellers) with very high power, much more efficiency and more than 100,000 HP at 1500 rpm with less weight than turbines and for speeds similar to current commercial aircraft (1000 kmts./Hr.).

Additionally, said engine still operates at low exhaust temperatures, practically undetectable by infrared and are very silent. Without using any reducer or flow diverters for braking, only the reversible turbofan, or piped reversible propeller. It can be used in supersonic airplanes with a very special design adding one or more axial or centrifugal turbochargers, combustion chambers and expansion, this mixed engine would be extremely efficient and would not need a turbine. In addition to vertical take-off planes, helicopters, etc.

The compression ratio can increase to a very high value without detonation, as the air and fuel cool down beforehand.

The exhaust valves work at low temperatures and low pressures. This fact contributes to the fact that simpler production processes and materials can be used, reducing manufacturing costs. Among the materials that could be used, we have aluminum, titanium, stainless steel, among others.

Although it is very different from the engines most used today, the production lines can easily adapt to manufacture this engine quickly with low cost.

In the design of these engines any of the possible combinations can be used, being able to use a single or several different sectors and any number of combustion and/or compression chambers in each sector, which may vary between them.

Said engine could still be used for energy production, in thermoelectric form, using only ⅓ of fuel and machines with power greater than 1000 MW, of an extremely small size and super economical, could still be manufactured.

When we think about the use of said engine in boats, for example, the desired speed could be almost doubled with the same fuel consumption.

Last but not least, the present engine contributes to the health of the planet, as global warming would be reduced, since there would be much reduction in the rates of CO2 emission into the atmosphere.

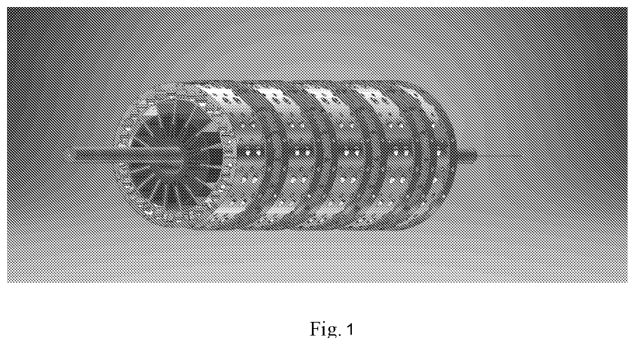

Specifically with respect to the structural arrangement of the engine of the present invention, it may comprise only a single sector or comprise a plurality of sectors that work together as if they were a single engine, as shown in FIG. 1.

Said sectors are ordered according to the design of the engine, the engine may have one or more sectors in their different shapes, sizes, order and composition for each particular use.

Particularly, FIG. 1 shows the assembly of an internal combustion engine without the external elements. Said engine is provided with several orifices for the entry and exit of gases and liquids in each sector of the engine.

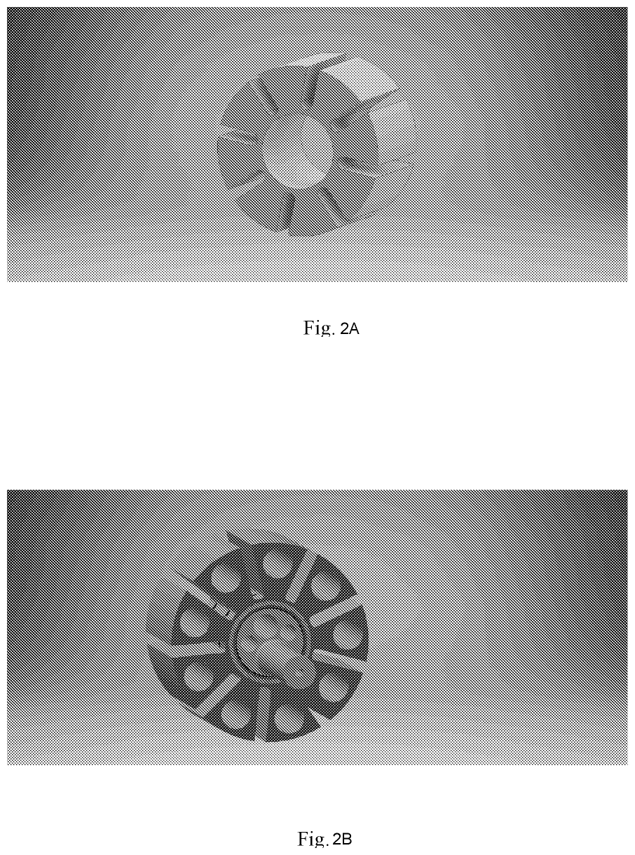

In a preferred embodiment of the present invention, an engine is provided comprising several sectors along its longitudinal axis, which are provided in its interior with cylindrical structures, in the form of a ring and herein referred to as subassembly. Said subassemblies are better detailed by FIGS. 2A, 2B, 3A, 3B, 5A and 5B).

Particularly, said sub-assemblies (ring) adjust to the outer diameter of its own cam throughout its length, in addition to having free rotation on the cam. The eccentric forms an inseparable part of the engine, which also comprises its shaft and its ring, these elements being fixedly mounted together the shaft with the eccentric and free the ring with the eccentric, as shown in FIG. 2B. The shaft and eccentric can be one piece in single sector engines, but in more than one sector engines they must be separated and fixed together later when final assembly is done see FIG. 11.

A person skilled in the art will understand that dimensions, amounts of rings, amounts of additional elements in each ring, shapes and compositions may vary according to the design of the engine. However, the engine shaft and eccentric can vary as the composition, size and shape and rotate together inside the ring that just oscillates.

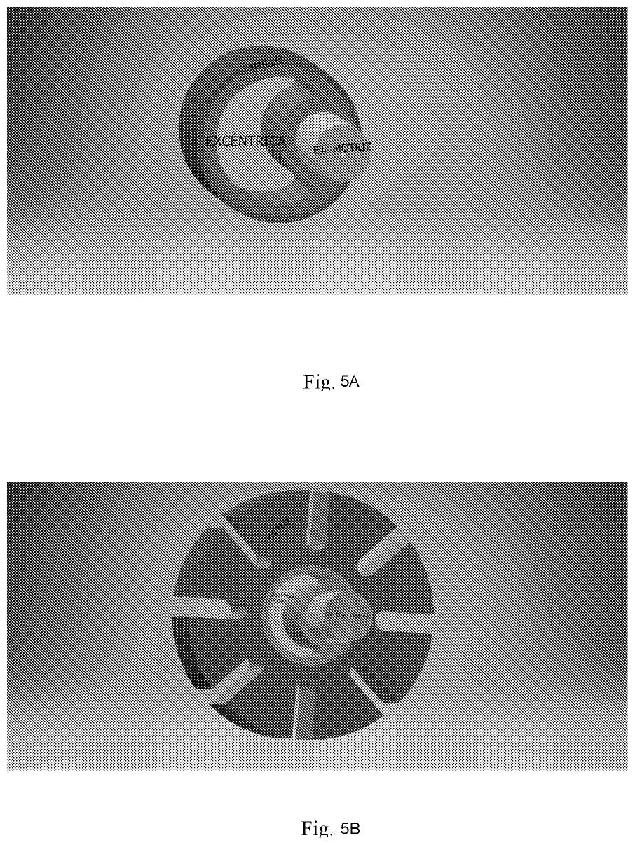

In a preferred embodiment of the present invention, FIG. 5B shows an engine with 8 combustion or compression chambers, while FIG. 2B shows an engine with 9 combustion or compression chambers. These Figures show a cross section of the engine, showing the main subassembly, the ring in red.

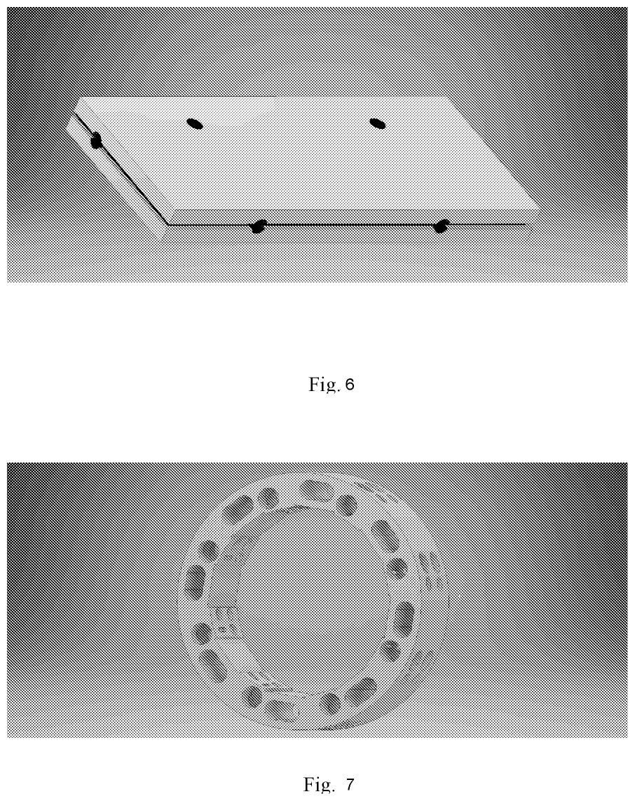

FIG. 6 of the present invention shows the additional elements of the engine, such as the blades-seals, which work together with the subassemblies. Said paddles are arranged one in each groove of the subassembly or one in each groove of the frame block.

The blades slide inside the grooves with the force of their springs or air pressure, which are not shown in the Figures, against the subassembly or against the structure-block and promoting a division of the empty internal space of each sector into combustion or compression chambers.

The surfaces of the seal blades are where the sealing occurs by means of a sliding-oscillating movement against the ring or against the block-structure and laterally reciprocally sliding against the engine covers.

The sub-assemblies are elements responsible for the operation of the engine presented here. If the ring (sub-assembly) is not present in the project, the engine would only work with the seal blades in the block and the relative speed would be very high against the eccentric, the part that the lubrication would be weak, so the engine could only have low rpm and its useful life would also be very low, the emissions would also be very high, because if it would be necessary to use a lot of oil, nor if they could manufacture large engines, these would be impossible due to the very high relative speed.

The engine shaft rotates together when the cam goes into motion. However, during the rotary movement of the engine and eccentric shaft, the ring, the sub-assembly, oscillates as it becomes free, as shown in FIGS. 5A and 5B.

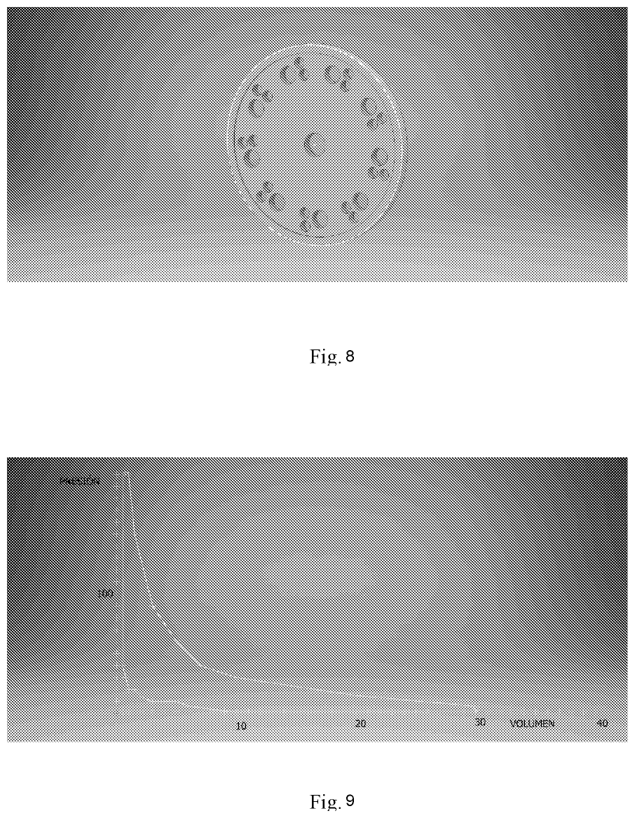

In the present invention, the combustion or compression chambers are formed by the closed internal space for combustion between the parts (sub-assemblies), which is formed by two intermediate or final covers, a carcass (frame, structure or block), two consecutive spades and the ring. FIG. 8 shows this coverage, which separates the different sectors that make up the engine and can vary in size, shape and composition according to the project.

The greater the number of combustion chambers in a project, the greater the number of explosions per revolution and smoother, more resistant, more efficient and with a long service life.

The main benefit of the presence of the ring in the engines of the present invention is the relative speed between it and the seal blades, this is many times smaller than that applied to current engines.

With this, the wear of the blades and all other elements of the engine is much lower. The engine revolutions per minute can be increased several times, which allows to make engines smaller, lighter and with higher rotation speeds, even though these have practically no limits in power and size.

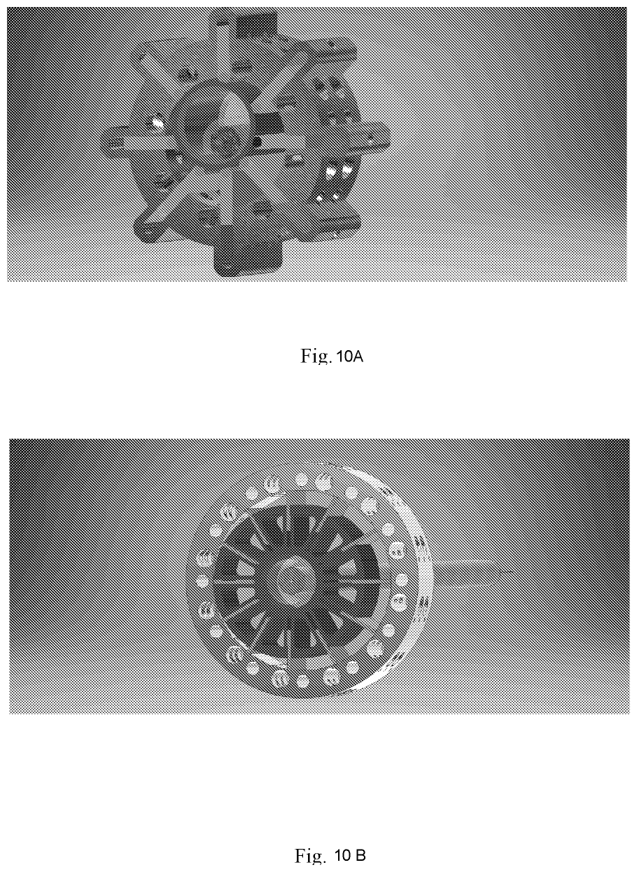

The sub-assemblies of the seal blades are provided with at least one push spring at the innermost end of each seal blade or pressurized air. Said springs are not shown in the Figures accompanying the present application. In particular, said springs are arranged against the ring or against the block, pushing against them as appropriate, as shown in FIGS. 2B, 10A and 10B.

Said engine also comprises valves for the entry and exit of combustion and compression gases not shown in the figures.

FIG. 9 of the present invention shows a theoretical thermodynamic profile representative of pressure-volume of the present internal combustion engine. A person skilled in the art recognizes that this particular thermodynamic cycle is extremely efficient, with very great fuel savings.

The present invention provides the technique of a ring as a whole in which the relative speed between said ring and the seal blades is extremely low, which allows an excellent lubrication of the system, adequate sealing, durability and minimal consumption of lubricating oil. Therefore, the wear of the seal blades is reduced and the engine revolutions per minute can be significantly increased, which allows to make engines of smaller size and weight, for high power, high speed (rpm), high efficiency, low consumption, low pollution rate and long service life.

The invention described herein is not limited to this embodiment and, those skilled in the art, will realize that any particular feature introduced therein should be understood only as something that has been described for ease of understanding and were carried out without departing from the concept described inventive. The limiting characteristics of the object of the present invention are related to the claims that are part of this report.

I claim:

1) The COMBUSTION ENGINE WHEREIN comprises a structural arrangement for a universal internal combustion engine, composed of four main parts, these being: block-structure in the form of an internally toothed washer that remains fixed (FIG. 7); shaft with an eccentric (FIG. 5A) in the center of the frame-block, on which it is coupled to; external toothed washer (FIG. 2A) that performs a circular translation movement on the shaft; the parallelepiped-shaped paddle-seals (FIG. 6), which are fitted in the grooves of the toothed washer externally (FIG. 2A), generating radial movements and also embedded in the grooves of the toothed washer internally (FIG. 7) resulting in lateral movements.

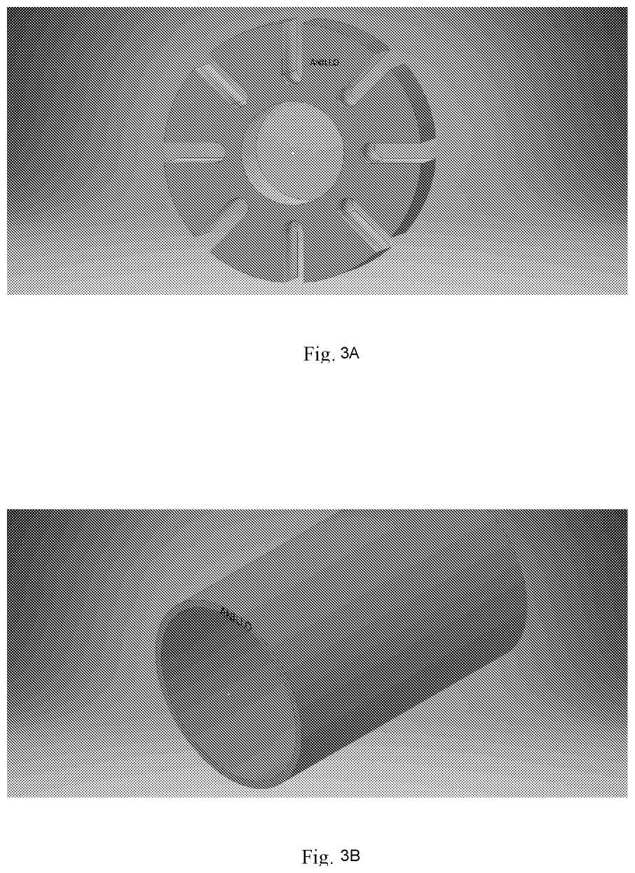

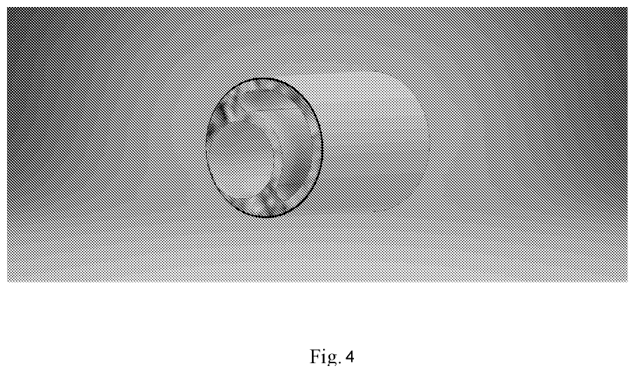

2) The COMBUSTION ENGINE, according to claim 1, WHEREIN comprises an external toothed washer (FIG. 2A) or an inner flat washer (FIG. 3B) that adjusts to the outer diameter of its own eccentric along its entire length and has free rotation on the eccentric.

3) The COMBUSTION ENGINE, according to claim 1, WHEREIN the eccentric, which further comprises its shaft and its washer, these elements being fixedly mounted together, the shaft with the eccentric and in a manner swivel, the washer with the cam (FIG. 2B).

4) THE COMBUSTION ENGINE, according to claim 1, WHEREIN the parallelepiped-shaped blade seals that slide inside the grooves of the externally toothed inner washer (FIG. 2A) and (FIG. 10B) with radial movements with respect to this washer (FIG. 2A), with the force of springs or compressed air, against the internally toothed outer washer/frame block (FIG. 7) and (FIG. 10B) or seal blades loosely fitted in the frame block grooves (FIG. 10A) sliding radially in the structure-block by the force of springs or compressed air and laterally in the interior flat washer (FIG. 3B) promoting, in both cases, the division of the empty internal space of each sector into combustion or compression chambers.

5) The COMBUSTION ENGINE, according to claim 1, WHEREIN performs the complete thermodynamic cycle in each turn, in which the compression is performed in stages with intermediate cooling (FIG. 9); after the compression stages, it is compressed to the maximum in the combustion chambers to burst/burn/burn in it and immediately take advantage of the energy obtained during the expansion of the gases inside the combustion chamber to complete the cycle.
